(19) United States
(12) Patent Application Publication
(10) Pub. No.: US 2014/0077751 A1
(43) Pub. Date: Mar. 20, 2014

(54) MODULAR ELECTRICAL ENERGY PRODUCTION DEVICE

(71) Applicants: Antoine Auberton-Herve, La Tronche (FR); Jean-Luc Delcarri, Saint Ismier (FR); Gilles Du Sordet, Saint Ismier (FR)

(72) Inventors: Antoine Auberton-Herve, La Tronche (FR); Jean-Luc Delcarri, Saint Ismier (FR); Gilles Du Sordet, Saint Ismier (FR)

(73) Assignee: SOITEC, Bemin (FR)

(21) Appl. No.: 14/122,602

(22) PCT Filed: May 30, 2012
(86) PCT No.: PCT/IB2012/001048

§ 371 Date: Nov. 26, 2013

(30) Foreign Application Priority Data
May 31, 2011 (FR) 1101672

(51) Int. Cl. H02J 3/00; H02J 7/35; H02J 9/04

(52) U.S. Cl. CPC H02J 3/005; H02J 9/04; H02J 7/35
USPC 320/101; 307/80; 307/66

(57) ABSTRACT

A modular electrical energy production device that includes a plurality of input connectors; a regulator unit coupled electrically to the input connectors; a converter unit, a storage device and an optional first output connector, coupled electrically to the regulator unit; a control unit; and a second output connector coupled electrically to the converter unit. The invention also concerns an electrical energy production system that includes a first modular electrical energy production device and a second modular electrical energy production device.

### TECHNICAL FIELD AND PRIOR ART

It is sometimes necessary to have an electrical energy source available on an isolated site, that is to say on a site that is geographically far away from the main electrical power distribution network. This is the case for example in situations of temporary intervention, such as humanitarian intervention, for example, on infrastructure construction sites or in the event of failure of the main electrical power distribution network.

A known solution for providing electrical energy on such a site is based on the transformation by a generator of fossil energy (petrol, diesel) into electrical energy. However, the question then arises of the provision of fossil energy in sufficient quantities, which may be problematic in some situations.

Also known are portable electrical energy production devices based on the use of renewable energy. In US 2007 0013340 an electrical energy generation unit constituted of a photovoltaic panel delivers electrical energy to an electrical energy production device that comprises a regulator unit, a transformer unit and a storage device.

This system is not suitable for supplying electrical energy on an isolated site where the demand for electrical energy is high or if a required degree of performance must be guaranteed or if the requirements for electrical energy are dispersed over an isolated site that covers a large area.

An object of the invention is to remedy the aforementioned drawbacks by enabling the installation of a local electrical power distribution network rated for the electrical energy requirement of the site and easily adaptable to those requirements should they change.

### SUMMARY OF THE INVENTION

The above object is achieved with a modular electrical energy production device comprising:
a plurality of input connectors;
a regulator unit coupled electrically to the input connectors;
a converter unit, a storage device and an optional first output connector, all coupled electrically to the regulator unit;
a control unit; and
a second output connector coupled electrically to the converter unit.

With the modular device of the invention, it is possible to couple electrically a variable number of electrical energy generation units to the modular device in order to adapt the electrical energy production capacity to the requirements of the site.

Moreover, the first output connector may be associated with an input connector of another modular electrical energy production device similar to that of the invention with the aim of forming an electrical power distribution network and thus assuring the supply of energy to a site.

The invention also concerns an electrical energy production system comprising a first modular electrical energy production device and a second modular electrical energy production device, the output connector of the first modular device being coupled electrically to an input connector (2.1, 2.2, 2.3) of the second modular device (DM2).

### BRIEF DESCRIPTION OF THE FIGURES

FIG. 1 represents a modular electrical energy production device.

FIG. 2 represents an electrical energy production system.

### DETAILED DESCRIPTION OF EMBODIMENTS OF THE INVENTION

The present invention concerns a modular electrical energy production device (DM) that may also be referred to as a “modular device” in the remainder of the description. By “electrical energy production device” is meant a device delivering electrical energy conforming to a standard and directly usable by a user device. By modular device is meant a complete and autonomous device that may be combined with other identical devices in order to extend the operating domain thereof.

This device has a dimension that enables it to be easily transportable on site. It may for example be of cubic or parallelepiped shape having a characteristic dimension (length, side) not exceeding 2 metres, or 1 metre, and a weight not exceeding a few hundred kilogrammes, such as 200 kg, or even 50 kg.

The elements constituting the modular device (DM) are assembled in and protected by a structure (10) made from a robust material enabling its transportation. The structure is preferably sealed.

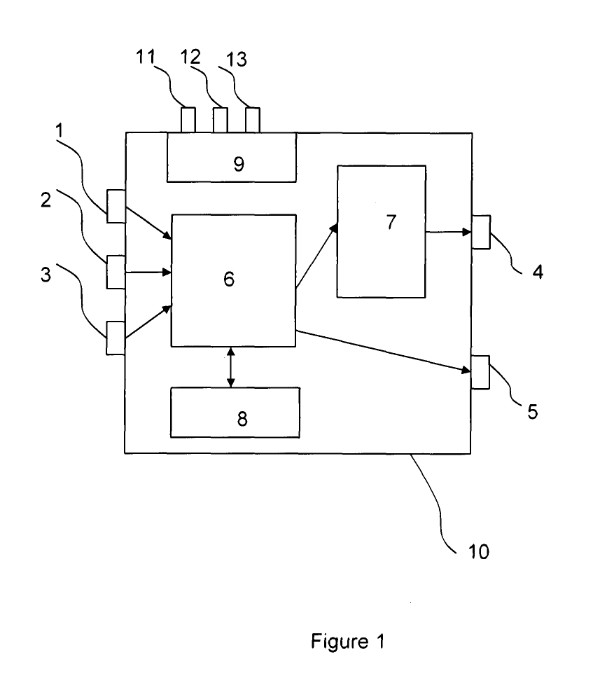

As is shown in FIG. 1, the modular device (DM) is provided with input connectors (1, 2, 3) enabling the modular device (DM) to be coupled electrically to a plurality of electrical energy generator units. It is thus possible, depending on the electrical energy capacity required on the site, to deploy a variable number of these units. The device is preferably provided with at least three input connectors (1, 2, 3). As will be described hereinafter, these input connectors also enable the modular device (DM) of the invention to be coupled electrically in series to another modular device also conforming to the invention to form an electrical power distribution network local to the site. The electrical energy generator units may be photovoltaic panels, preferably of the concentration type, or wind turbines, or any other type of electrical energy generator unit, but preferably of the type generating electrical energy from renewable energy. The electrical energy generator units coupled to the modular device (DM) may be of the same type or different types. Accordingly, by using units that generate electrical energy from renewable energy, it is possible to supply electrical energy on an isolated site, i.e. one with no access to the main electrical power distribution network, and it is not necessary to provide for the supply of fossil energy.

The input connectors (1, 2, 3) are coupled electrically to a regulator unit (6), itself coupled electrically to a converter unit (7), to a first output connector (5) and to a storage device (8).

The functions of the regulator unit (6) is to deliver the required electrical energy to the converter unit (7) and the first output connector (5). The regulator unit (6) also controls the storage device (8), that is to say it alternates the charging, rest and discharging cycles of that unit. The storage unit is preferably constituted of one or more electrical batteries, for example of the ion-lithium ion type.

The regulator unit is preferably associated with the control unit (9), which may provide additional information such as the outside temperature for example or the temperature of the storage device, the level of charge of the storage device, in order to optimize the quantity of electrical energy stored.

As described above, the converter unit (7) is coupled electrically to the regulator unit (6). The converter unit is also coupled electrically to the second output connector (4). The function of the converter unit (7) is to supply at the second output connector (4) electrical energy in the form required or to the required standard. This may be a direct current voltage of 9 V for example or any other value or an alternating current voltage of 220 V at 50 Hz or a voltage conforming to any other specification.

The regulator unit (6) is also coupled electrically to the first output connector (5).

This first connector (5) enables electrical coupling of the modular device (DM) with another modular device of the invention in order to form an electrical power distribution network on the site, as will be described in detail hereinafter.

In one particular embodiment of the invention the second output connector (4) coupled to the converter unit (7) enables electrical coupling of the modular device (DM) with another modular device of the invention in order to form an electrical power distribution network on this site, and comprises the role of the first output connector (5).

In one particular embodiment of the invention it is also possible to use an existing electrical coupling between two modular electricity production devices to transfer information between the control units (9) of two coupled modular devices. A carrier current communication technique could be used for example. One example of application of this is communication between two coupled modular devices of the level of charge of their respective storage devices. This information may be used to control the strategy of operation of the regulator units (6) of the power distribution network.

The modular device of the invention also comprises a control unit (9). This unit may be connected to all of the elements of the modular device described hereinabove with the aim of controlling them and optimizing the operation of the modular device and/or the electrical power distribution network. It also enables collection and provision of information from and to all these elements. Moreover, it may equally be connected to a control and display panel (not represented in FIG. 1) for input and output of information or instructions by and to a user.

As stated hereinabove, the control unit (9) may also be in communication with the control units of the other modular devices of the network. To this end it may have available a communication sub-unit employing a communication protocol and a carrier current or wireless, for example wifi, communication technique.

The control unit (9) may also have available a set of information sensors, such as a temperature sensor, a geographical position (GPS)—clock sensor or a sensor for any other information useful for the operation of the modular device.

The communication with the control unit thus allows thus easy maintenance and management, for instance by distance, of a single modular device or of an electrical power distribution network of several coupled modular device. It could be used to anticipate or intervene on any occurring problems, as for example breakdown of a modular device in the network or irregularities in the consumption, handling, or storage of electrical energy in a modular device.

The control unit may also be provided with exterior connectors (11, 12, 13) enabling it for example to be connected to a diagnostic device (in this case the connector may be a simple USB port), to be connected to external information sensors, or to communicate with a control unit of another modular device by means of a dedicated cable.

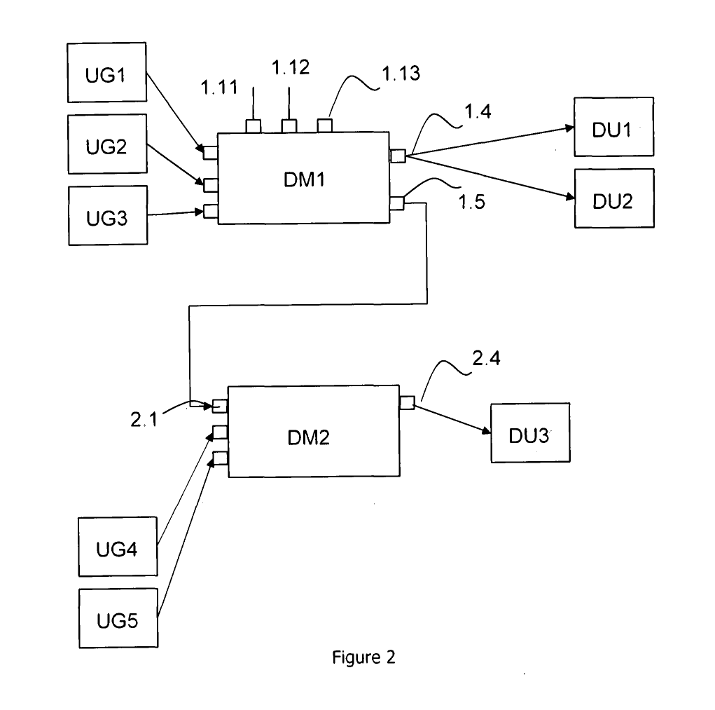

A preferred embodiment of the modular device of the invention is described in detail next with reference to FIG. 2.

A first modular device DM1 and a second modular device DM2 are disposed on an isolated site. The first output connector 1.5 of the first modular device DM1 is coupled electrically to one of the input connectors 2.1 of the second modular device DM2 by a connecting cable. The output connectors 1.4 and 2.4 are connected to user devices DU1, DU2 and DU3 in the configuration represented in FIG. 2. Thus a local electrical power distribution network has been formed on the isolated site. The first modular device DM1 is electrically coupled to one or more electrical energy generator units (UG1, UG2, UG3).

In an alternative embodiment of the invention (not represented), the first output connector 1.4 of the first modular device DM1 is coupled electrically to one of the input connectors 2.1 of the second modular device DM2 by a connecting cable.

In a preferred embodiment of the invention the generator units (UG1, UG2, UG3) are concentration type photovoltaic devices. Concentration type photovoltaic devices are particularly suitable for use on an isolated site, as they are capable of generating a relatively high power, generally necessitate no water for their operation or for cooling them, and may be available in the form of a set of transportable elements. They may for example be concentration type photovoltaic devices sold under the brand Soitec™, using the Concentrix™ technology and distributed by the company Soitec Solar GmbH. As is well known, a concentration type photovoltaic device is composed of a set of photovoltaic modules assembled on a mobile base provided with a 2-axis orientation mechanism. This mechanism enables automatic orientation of the surface of the modules perpendicularly to the sun's rays throughout the day, thus maximizing the energy produced. Each concentration type photovoltaic device may have a module active area in the range 0.35 m² to 10 m², for example of the order of 3 m², and produce electrical energy in the range 75 kW peak to 2000 kW peak. This range of surface and related power allows keeping the dimension of the generator unit sufficiently small to allow its easy transportation and installation, and to keep it transportable. At the same time, these dimensions for a concentration type photovoltaic device are sufficient to generate electrical energy to operate the system without interruption for most envisaged applications.

Each photovoltaic device is thus provided with motors for orienting the modules, the motors being themselves connected to a regulating sub-unit of the control unit (1.9) of the first modular device (DM1) by a connecting cable. The regulating sub-unit of the control unit (1.9) uses the information supplied by the integrated position-clock sensor (such as a GPS sensor) to control the motors of each concentration type photovoltaic device and to position their bases according to an estimated orientation of the sun. The regulating sub-unit of the control unit (1.9) is also capable of controlling the movement of the motors in order to optimize the orientation of the base to maximize the power supplied by each photovoltaic device, for example on the basis of the data delivered by a solar sensor installed on the base and connected to one of the exterior connectors (1.11, 1.12, 1.13) of the control unit (1.9).

The first modular device (DM1) may also be connected at a connector (1.11, 1.12, 1.13) of the regulating sub-unit of the control unit (1.9) to an anemometer in such a manner as to position the photovoltaic modules in a safe (horizontal) position in the event of an excessive wind speed (typically above 12 m/s).

In an alternative embodiment, the regulating sub-unit of the control unit (including for instance the information sensors like the geographical position (GPS)—clock sensor) may be located, partially or entirely, on the generators units (UG1, UG2, UG3), like for instance a concentration type photovoltaic device'. This configuration allows simplifying the interconnection of. the generator units (e.g. concentration type photovoltaic device) with the modular device.

In this preferred embodiment of the invention, the concentration type photovoltaic devices enables the supply during the hours of sunshine of electrical energy enabling not only supply of power to the user devices (DU1, DU2, DU3) but also charging of the storage device (1.8) of the modular device (DM1), and even charging of the storage device (2.8) of the modular device (DM2).

The second modular device (DM2), in a similar way to the first modular device (DM1) may be coupled electrically to one or more generator units (UG4, UG5), for example wind turbines, at the input connectors (2.2, 2.3).

The modular device of the invention thus enables an electrical power distribution network to be formed on an isolated site, extendable as required by adding additional modular devices connected in series. Each modular device may be coupled electrically to one or more electrical energy generator units or to another modular device. During periods of low generation of electrical energy by the generator units or of high consumption of electrical energy the storage devices of each modular device enable balanced delivery of electrical energy to the power distribution network.

1.-16. (canceled)

17. A modular electrical energy production device comprising:
a plurality of input connectors;
a regulator unit coupled electrically to the input connectors;
a converter unit and storage device coupled electrically to the regulator unit;
a control unit; and
a second output connector coupled electrically to the converter unit.

18. The device of claim 17, further comprising a first output connector coupled electrically to the regulator unit.

19. The device of claim 17, wherein the storage device comprises at least one electrical battery.

20. The device of claim 19, wherein the electrical battery is an ion-lithium battery.

21. The device of claim 17 wherein the control unit comprises a regulating sub-unit.

22. The device of claim 21, wherein the regulating sub-unit comprises a GPS position-clock sensor.

23. The device of claim 17, wherein the control unit a temperature sensor.

24. The device of claim 17, further comprising a display and control panel to which the control unit is connected.

25. The device of claim 17, wherein the control unit comprises a communication sub-unit.

26. The device of claim 17, wherein the control unit is connected to at least one exterior connector.

27. The device of claim 26, further comprising a concentration type photovoltaic device electrically connected to one of the input connectors.

28. The device of claim 27, wherein the concentration type photovoltaic device comprises a photovoltaic module or a mobile base provided with a 2-axis orientation mechanism.

29. The device of claim 27, wherein the photovoltaic module has a module active area in the range 0.35 m² to 10 m².

30. The device of claim 27, wherein the concentration type photovoltaic device comprises a regulation sub-unit.

31. An electrical energy production system comprising at least a first modular electrical energy production device and a second modular electrical energy production device each according to claim 17, with the first or second output connector of the first modular device being coupled electrically to one of the input connectors of the second modular device.

32. The electrical energy production system according to claim 31, further comprising at least one electrical energy generator unit coupled electrically to one of the modular electrical energy production devices.

33. The electrical energy production system according to claim 32, wherein the electrical energy generator unit is a concentration type photovoltaic system.
